(19) United States
(12) Patent Application Publication
(10) Pub. No.: US 2025/0044759 A1
(43) Pub. Date: Feb. 6, 2025

(54) Moisture Control System for Clay Tennis Courts

(71) Applicant: Scott Dilling, Canton, OH (US)

(72) Inventor: Scott Dilling, Canton, OH (US)

(21) Appl. No.: 18/792,743

(22) Filed: Aug. 2, 2024

Related U.S. Application Data
(60) Provisional application No. 63/517,445, filed on Aug. 3, 2023.

(51) Int. Cl. G05B 19/042

(52) U.S. Cl. CPC G05B 19/042; G05B 2219/2625

(57) ABSTRACT

A moisture control system for use on a clay tennis court is disclosed. The moisture control system uses moisture sensors that are buried within the clay court playing surface along with an electronic control module and corresponding software to energize electronic water valves as needed for each end of the court (or zone) so that the moisture level within the clay playing surface is maintained within user-specified controlled limits. Water flow sensors that are connected to each water valve provide the user with current flow rate measurement, thus allowing the user to adjust the flow rate on each water valve as needed. The control module includes an LCD display as well as two-way Wi-Fi communication with a mobile wireless communication device such as a smart phone.

### CROSS-REFERENCE TO RELATED APPLICATION

The present application claims priority to, and the benefit of, U.S. Provisional Application No. 63/517,445, which was filed on Aug. 3, 2023, and is incorporated herein by reference in its entirety.

### FIELD OF THE INVENTION

The present invention relates generally to the field of clay tennis courts and the need to maintain proper moisture within the court playing surface. Specifically, the present invention provides an improved moisture control system for clay court surfaces. Since clay courts need to stay moist, water must be supplied to either the top surface or from below the surface to maintain proper moisture levels throughout the clay court playing surface. Changes in temperature, sun/clouds, and rainfall require frequent adjustments to the water flow and/or the cycle time to maintain proper moisture levels. Too little water will allow the clay court surface to dry out, thus making it slippery, dusty, and hard to play on it. On the other hand, too much water can cause the court surface to become wet and soft, making it unplayable. Current irrigation systems for clay courts are manual-controlled and do not automatically adjust for changing weather conditions. The present invention overcomes many of the common issues found with current irrigation systems for clay courts, including that of changing weather conditions.

Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, tennis, pickleball, and similar sports use a flat playing surface typically made from asphalt, concrete, sand, clay, ground stone, or grass. The pace of play, the bounce of the ball, and other factors related to the sport can be greatly affected by the playing surface. For instance, a tennis court having a hard-court surface (i.e., asphalt or concreate) leads to a faster-paced game with higher bounce on the ball, while a tennis court having a clay court surface (clay or ground stone) leads to a slower-paced game with lower bounce on the ball, thus requiring the players to adjust their game based on the court playing surface. Further, hard surface courts allow players to move and stop quickly, while the clay court surface requires players to anticipate sliding motion upon starting and stopping. An additional benefit of playing on clay court surfaces has been found to be easier on the player's body including their knees and ankles. Finally, due to the moisture within the clay court surface, playing on a clay court can be significantly cooler than playing on a hard-court surface.

As previously stated, clay courts made from clay or ground stone rely on a significant amount of moisture to create the necessary compaction of the materials, which hold them together to form the court surface. Water is added to either the top of the playing surface or below the playing surface, thus causing the court material to absorb the water making the court playing surface moist. Proper material selection is necessary such that the water will be absorbed much like a sponge absorbs water. It has been found that a preferable material for clay tennis courts is meta basalt greenstone rock, which is naturally found in the Blue Ridge Mountains of Virginia. This material is crushed to meet specific size requirements and mixed with gypsum. After being processed to achieve the proper size, the ground stone (commonly referred to as “clay”) is spread over the tennis court surface and then rolled to give it proper compaction. Water is added to either above or below the ground stone surface to give the material its proper moisture content. Much like adding water to sand when building sandcastles at the beach, clay tennis courts rely on the proper amount of moisture to give the playing surface its optimal performance for players.

Since water evaporates from the clay court surface, additional water must be added to the clay court material so that it maintains its proper moisture level. Two common methods for “watering” a clay court are (i) from above the surface much like a typical irrigation system for a grass lawn, or (ii) from below the surface via a network of piping system. The above ground irrigation system may include a timer and operate much like a typical lawn sprinkler system. The main drawback for this type of irrigation system is that it cannot operate when tennis players are using the court. The second type of irrigation system for the clay court supplies water to the clay or ground stone material from below the surface. In this system, water flows through one or more pipes situated below the surface of the court. The pipes typically have multiple holes or nozzles for even-distribution of water throughout the entire court surface thereby creating a water table below the surface of the court. The below-the-surface irrigation system has the advantage of allowing tennis players to play on the clay tennis court while the irrigation system is supplying water to the court material. Clay court material and irrigation systems are commonly sold by companies like Har-Tru, LLC of Troy, Virginia.

The below-the-surface irrigation system typically supplies water to the court surface 24 hours of the day regardless of the current weather conditions. Typically, a tennis professional or maintenance personnel must check and/or adjust the amount of water flow through the underground irrigation system on a regular basis. On cloudy or cool days, the water flow through the system may need to be reduced or possibly even shut-off if there was a recent period of heavy rain. On sunny, hot days the water flow may need to be increased so that the court surface does not dry out. Further, the court moisture can significantly change throughout the day. For instance, in the morning hours before the full sun is on the court surface, the court may be extra moist. As the day goes on, the afternoon sun may cause the court surface to dry-out. Thus, the play conditions of the clay court can vary greatly depending on how frequent the inspections are performed by the tennis professional or maintenance personnel.

The below-the-surface irrigation system is typically controlled by two or more shut-off valves that are located near the tennis court inside an enclosure typically called a “valve box.” It is common to have the clay tennis court separated into separate areas, called “zones.” Each zone is controlled by a separate shut-off valve in the valve box. Usually, each end (or half) of the court is separated into one or more zones. The more zones that the court is separated into, the better control of moisture throughout the entire court surface. For instance, a portion of the court may be shaded due to trees while another portion of the court gets direct sunlight. Additional zones will add complexity and cost to the irrigation system. Commonly, one zone is assigned to each end of the court. Sometimes, two clay courts are positioned next to each other and share one common valve box. In this case, one main water supply line coming into the valve box will be split into four shut-off valves, controlling two zones on each of the two courts.

The water flow rate for each zone is controlled by adjusting the handle on each of the shut-off valves inside the valve box. The water flow rate for each zone may be different due to many factors including sun or shade on the court, the distance from the valve box to the zone location on the court (i.e., one end of the court will be closer to the valve box), or other factors specific to the individual tennis court. Sometimes, the valve adjustment process is trial-and-error. This is especially true at the beginning of a tennis season. It may take several days to get the individual zones on the court(s) adjusted so that they are receiving enough water, but not too much. In fact, if the water flow rate is too excessive it may cause the excess water to come to the surface of the court, thus flooding the court with water. Again, it's like a sponge soaking-up water. The sponge can only absorb so much water. Excess water cannot be absorbed any longer into the sponge leaving the excess water behind. The same principle applies to the clay tennis court material.

A typical zone on a clay tennis court may only require between 2-6 gallons per minute of water flow to maintain a stable moisture level for a given zone. Most water inlet pipes supplied to a valve box use a ¾-inch pipe that can provide 20-40 gallons of water per minute. To reduce the flow rate to the proper rate for each zone, the professional (or user) may have to partially close the main shut-off valve as well as each zone shut-off valve. This is where the trial-and-error comes into play. Using traditional engineering equations for flow though pipes, it can be shown that the summation of all the flow rates through the individual zone shut-off valves is approximately equal to the total flow rate through the main shut-off valve. So, adjusting one of the zone shut-off valves will change the flow rate through the remaining valves. By example, reducing the flow rate in one zone shut-off valve will increase the flow rate through the remaining zone shut-off valves. There are more complicated ways to get around this problem, such as flow regulators, but this can add significate cost and maintenance to the irrigation system.

To further complicate the valve adjustment process, the clay material takes a certain amount of time to absorb the water flowing below its surface. The absorption rate of the water into the clay material, as well as the filling rate of the water table below the clay material can take several minutes or possibly longer to stabilize after a change to one or more of the shut-off valves is made within the valve box. This time delay adds to the complexity of the trial-and-error process.

One solution on the market today attempts to automate this process by using a float and manual shut-off valve, much like how a float and manual valve operate inside a standard toilet tank. In this system, the user still must use trial-and-error to determine the proper water level in the water table that is below the clay surface material. Once adjusted, the water table level will control the manual valve to add additional water when it is needed. While this system is an improvement to the shut-off valve adjustment method, actual water flow rates through each zone is unknown possibly leading to flooding of the court. Further, the user still needs to regularly check the irrigation system and court to make sure the court surface is receiving the proper amount of moisture.

Therefore, there exists a long felt need in the art for an improved moisture control system that can be easily installed onto new and existing clay court irrigation systems. There is also a long felt need in the art for an improved moisture control system that can control the moisture level within a clay court surface based on current climate conditions. There is a long felt need in the art for an improved moisture control system that can be adjusted by a user to select the desired moisture level for individual zones on a clay court. There is a long felt need in the art for an improved moisture control system that can use wireless communication to give current moisture level information back to the user without the need for the user to physically inspect the court. Finally, there is a long felt need in the art for an improved moisture control system that can measure the water flow rate through each zone, thus making the zone balancing process much quicker and easier for the user.

The subject matter disclosed and claimed herein, is an improved moisture control system that is designed to be installed as part of an irrigation system for a clay court the purpose of controlling the moisture level in each zone of the clay tennis court. The improved moisture control system includes one or more moisture sensors that are placed below the surface level of the clay court. In addition, the improved moisture control system includes a control unit that can read the moisture level at each moisture sensor and determine if the moisture level within the zone is between the user-specified lower and upper limits. Since the actual moisture levels are measured at each sensor, the improved moisture control system can adjust as needed regardless of the current weather conditions. The improved moisture control system replaces the manual shut-off valves for each zone with an electrically controlled valve. The improved moisture control system further includes a flow rate sensor that is placed in-line with each electrically controlled valve. Each zone includes an adjustable flow rate, which is preferably part of the electrically controlled valve. The improved moisture control system can be placed inside the existing valve box or located at another location specified by the user. Finally, the improved moisture control system can be controlled by the user at the control unit or remotely via a mobile device or computer using a novel software program that is installed on the control unit.

The improved moisture control system uses a capacitive style moisture sensor as opposed to a resistive type sensor. The capacitive sensor has been successfully used to measure the moisture in soil for gardens, plants, and other applications and has been proven to be more reliable than the resistive type of sensor. However, there are still issues that must be considered when using the capacitive moisture sensor. This moisture sensor has a portion of the sensor that is to be placed in the ground to measure moisture content. The upper portion of the moisture sensor must remain dry due to the electronic components that are needed for the sensor to function. In the garden application, the upper portion of the sensor can remain above ground and stay dry.

Keeping a portion of the moisture sensor above ground is not possible in the clay tennis court application. The sensor must be completely out of the way of the tennis players. Therefore, the moisture sensor cannot be buried in the clay surface of the court without the electronics on the upper portion of the sensor getting wet, which may cause the sensor to stop working. In addition to damaging the sensor, the control unit may become damaged as well. Finally, it has been reported by many users of this moisture sensor that over a period of time, water can make its way into the edges of the printed circuit board of the moisture sensor. This can shorten the life and accuracy of the sensor if this were to occur. To overcome the issues mentioned above related to the normal garden application of the moisture sensor, some have tried painting the edges of the sensor, as well as the electronic components on the upper portion of the sensor. Some have even placed special heat shrinkable tubing over the electronics on the sensor to keep it from getting wet.

While making some improvement to the issues mentioned previously when the sensor gets wet, this is still not acceptable in the clay court environment where the sensor will be completely below the playing surface of the tennis court. There is a long felt need in the art for an improved moisture sensor that can be placed in a moist or wet environment without having to keep portions of the sensor from getting wet during use. The improved moisture control system includes an innovative enclosure for the moisture sensors used in the clay court application, which will protect the sensor from getting wet on the edges of the printed circuit board as well as the electronics portion of the sensor.

Like the moisture sensor, the control unit of the improved moisture control system must remain dry as well. Ideally, the control unit should be placed inside a weather resistant electrical box. Most weather resistant electrical boxes include a seal between a hinged lid and box base, making the interior portion of the box resistant to rain. However, the box only stays water resistant if there are not mounting holes drilled into the box for mounting the control unit. Further, the control unit of the improved moisture control system includes a display panel for the user to interact with the control. The display panel must be attached to the electrical box in such a way that the user can also gain access to the printed circuit board that includes the micro controller and the attachment locations for the moisture sensors, flow sensors, the electronic valves, and the electric power needed to operate the system.

A new weather resistant box could be designed to meet the needs of the control unit for the improved moisture control. However, custom tooling needed to manufacture an injection molded plastic enclosure would be very costly. There is a long felt need in the art for an improved display panel and attachment device that can be easily attached to an existing weather resistant box. The display panel for the improved moisture control system includes an innovative plastic display panel and mounting components that use the existing mounting locations found within the box and does not require drilling any additional holes for supporting the display panel. Further, the innovative design also allows the display panel to pivot open thereby allowing access to the printed circuit board.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an improved moisture control system that is designed to be installed as part of an overall irrigation system for controlling the moisture level of clay tennis courts. The preferred irrigation system is one that is capable of supplying water to the clay surface material below ground level. The improved moisture control system could also be easily adapted for use on above ground irrigation systems as well. The moisture sensors would still be placed below the playing surface of the clay court, but the supply of water would be sprayed onto the top surface of the clay court material. So, instead of the water being supplied below the surface and absorbed all the way to the playing surface, this irrigation system would allow water to be applied on the playing surface and then absorbed into the material below the surface. This type of irrigation system may be preferred in some cases, but still has the disadvantage that tennis players cannot use the court while the above ground irrigation system is in operation. For this reason, most of the background and description of the improved moisture control system disclosed herein will focus on the below the surface type of irrigation system.

The improved moisture control system of the present invention is a closed-loop electronic system for controlling the amount of moisture on the surface and/or below the playing surface of a clay tennis court. The term “clay” used herein is a generic term used to describe the composition of material commonly used to create a typical clay tennis court. Since different compositions of clay and climate conditions exist, this device has the ability to adjust the lower and upper limits as specified by the user.

Further, each half (or end) of the court, as delineated by the court's net, is divided into one or more “zones.” Each zone controls a portion of the court independently from the other zones. Each zone has one or more moisture sensors, preferably four sensors per zone. The moisture sensors are electrically connected to the control unit. The control unit updates the moisture measurements for each sensor routinely as part of the software algorithm. The user can select between three measurement modes: (i) all sensors within the zone are averaged, (ii) the highest sensor within the zone controls the entire zone, and (iii) the lowest sensor within the zone controls the entire zone. This flexibility allows the user to determine what is optimal for each clay tennis court.

The lower and upper moisture control limits can be set by the user for each zone. Based on the zone control measurement mode selected by the user, the control module will turn-on the zone relay, which then energizes the water valve solenoid, when the moisture measurement falls below the lower moisture limit and turns-off the zone relay when it exceeds the upper moisture limit, thus de-energizing the water valve solenoid. Once the optimal settings are determined for each clay court, the user can simply monitor the moisture levels at each sensor throughout the day and only make adjustments when necessary. The improved moisture control system will continue to keep the moisture levels within the selected limits, thereby eliminating the need to continually monitor and adjust by the user. At some point, the user can simply let the improved moisture control system handle the moisture levels on the clay court on its own.

Should the user of the present invention decide that special circumstances require manual operation of the system, the user can select one of three modes of operation for each zone: (i) Auto, (ii) Manual On, or (iii) Manual Off. The user interface on the control module, as well as the Wi-Fi connected mobile device, can receive updates for each zone on a regular basis. In order to prevent unauthorized access, the control unit software includes password protection to limit access to the control module display, as well as the Wi-Fi connected computer and/or mobile device such as a cellular phone.

The control unit is capable of electronically storing configuration data as well as storing and executing custom software for controlling the innovative system as described herein. The control unit includes a micro controller, preferably a Raspberry Pi/Pico W, Arduino, or some other microcontroller or computer. The preferred software used in the control unit is a combination of MicroPython, Java Script, HTML (i.e., Hypertext Markup Language), and CSS (i.e., Cascading Style Sheets) programming. Other programming languages, such as C/C++ are viable as well. In addition to the microcontroller, the control unit also includes a plug-in 24 VAC power supply; a rectifier and 5 VDC voltage regulator for providing power to the microcontroller, display, and sensors; a display screen mounted to the front of the control unit; eight moisture sensors (four for each zone); two to four relays for providing 24 VAC to each of the irrigation valve solenoids; and two to four A/D (analog to digital) four-channel I2C serial modules for measuring output voltage at each moisture sensor, which is then converted into a corresponding moisture reading by the custom software program.

The improved moisture control system also includes a hall-effect flow sensor for measuring the water flow rate through each zone. The flow rate measurement is processed within the control unit and then displayed on the LCD screen of the display panel. Knowing the flow rate of the four zones simultaneously greatly facilities the water flow adjustment process through each zone. Manual flow adjustments can be made by turning the flow control know on each valve. As previously described herein, the traditional balancing process of balancing the flow rates without the novel present invention is a trial-and-error time consuming process. With the present invention, balancing the water flow rates for each valve only requires a minute or two to get to the desired flow rates.

Each moisture sensor can be calibrated by pressing the “Calibrate” button for the sensor. This can be accomplished by first making sure the installed sensor is complexly saturated with water. This can be accomplished by first packing each sensor enclosure with the clay material around the measurement end of the sensor. Then, positioning the sensor into the dugout hole at the desired location on the court. The dugout hole will typically go down about five to six inches until reaching the plastic liner placed below the clay material. This allows the water to be held, thus creating a water table below the playing surface. After tightly packing the clay material around the sensor, flooding the area with a bucket of water will approximate complete saturation as measured by the sensor. At this point, pressing the “Calibrate” button or either the display panel or the mobile device running the software program or webpage will cause the software algorithm to take ten sensor readings. The average of the ten sensor readings will be used to update the best-fit linear slope and offset value for the sensor such that when the sensor measures completely dry clay it will show a reading of approximately zero percent moisture and when completely saturated with water will show approximately one hundred percent moisture.

Other features of the improved moisture control system may be included in certain embodiments. For instance, the control unit may further include an internal battery source for supplying the control unit with power in the event of a power failure. The internal battery, preferably 4.5 volts direct current (DC) or more, can keep the control unit energized during a power outage. The microcontroller requires a minimum of 3 to 5 volts to keep it energized. One of the benefits of having an internal battery in the control unit would allow it to communicate with the user via the mobile device letting the user know of the power outage.

Still, other features of the improved moisture control system may include using the internal temperature sensor contained within the microcontroller to keep track of the temperature of the control unit, which could be communicated back to the user's mobile device. This could be helpful for a number of reasons. First, in extreme heat conditions, the user could become aware that the temperature is too high for normal operations. Specifically, the recommended operating temperature on the microcontroller is limited to about 150° F. Knowing the operating temperature could be beneficial for the user when determining a location for the control unit. Further, low temperatures approaching freezing conditions could alert the user so that they could manually shut-off the system remotely to prevent freezing of the water and/or the irrigation system.

Finally, the improved moisture control system can be configured to control either two or four zones using one control unit. This could allow it to be configured to control four zones on one tennis court or two tennis courts sharing one valve box having one zone per each end of the tennis courts. This can be accomplished by the user making changes to the setup within the control unit. Further, each moisture sensor can be assigned to a particular zone within the setup on the control unit. This will give the user flexibility in selecting sensor locations within the court and zones based on the individual layout of the clay tennis court. Finally, in the event of a moisture sensor failure, the user can remove the sensor from its assigned zone. This would allow the system to continue to operate using the remaining sensors within the zone until the user can have the sensor replaced.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a layout view of a prior art clay tennis court having a below ground irrigation system as per the disclosed design;

FIG. 2 illustrates a process flow diagram for the present invention improved moisture control system that can be incorporated into an irrigation system as shown in FIG. 1 as per the disclosed design;

FIG. 3 illustrates a perspective view of the control unit including the innovative mounting system of the display unit within the waterproof plastic enclosure as per the disclosed design;

FIG. 4 illustrates a perspective view of the control unit in FIG. 3 with the display panel in an open position to provide access the printed circuit board of the present invention as per the disclosed design;

FIG. 5 illustrates a perspective view of the printed circuit board shown in FIG. 4 of the present invention as per the disclosed design;

FIG. 6A illustrates an exploded perspective view of the innovative enclosure for the moisture sensor of the embodiment of the present invention as per the disclosed design;

FIG. 6B illustrates an exploded perspective view of the innovative enclosure for the moisture sensor of the embodiment of the present invention shown in FIG. 6A with moisture sensor now placed within the lower clamshell of the enclosure as per the disclosed design;

FIG. 7A illustrates an exploded perspective view of the innovative enclosure for the moisture sensor of the embodiment of the present invention shown in FIGS. 6A and 6B with moisture sensor now installed within the enclosure and ready for electrical connection as per the disclosed design;

FIG. 7B illustrates a sectional view of the innovative enclosure for the moisture sensor of the embodiment of the present invention shown in FIGS. 6A, 6B, and 7A with moisture sensor now completely encased by the enclosure and electrically connected as per the disclosed design;

FIG. 8 illustrates a perspective view of a prior art manual valve plumbing configuration for two manually operated zone valves attached to one manually operated supply line valve as per the disclosed design;

FIG. 9 illustrates a perspective view of a plumbing configuration for two electrically controlled zone valves attached to one manually operated supply line valve of the present invention described in FIG. 2 as per the disclosed design;

FIG. 10 illustrates a layout view of a clay tennis court having a below ground irrigation system with the improved moisture control system of the present invention now installed as per the disclosed design;

FIG. 11A illustrates a perspective view of the prior art waterproof plastic enclosure of the present invention shown in FIG. 3 as per the disclosed design;

FIG. 11B illustrates a frontal view of the prior art waterproof plastic enclosure shown in FIG. 11A showing the internal mounting locations on the back side of the box as per the disclosed design;

FIG. 12A illustrates an exploded perspective view of the innovative control unit depicting the innovative mounting system for the display panel and the waterproof plastic enclosure of the embodiment of the present invention shown in FIG. 3 as per the disclosed design;

FIG. 12B illustrates a partial sectional view of the innovative control unit depicting the innovative mounting system for the display panel and the waterproof plastic enclosure shown in FIG. 12A as per the disclosed design;

FIG. 13 illustrates a frontal view of a mobile device with the innovative software program or webpage displayed for the present invention as per the disclosed design.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for an improved moisture control system that can be easily installed onto new and existing clay court irrigation systems. There is also a long felt need in the art for an improved moisture control system that can control the moisture level within a clay court surface based on current climate conditions. There is a long felt need in the art for an improved moisture control system that can be adjusted by a user to select the desired moisture level for individual zones on a clay court. There is a long felt need in the art for an improved moisture control system that can use wireless communication to give current moisture level information back to the user without the need for the user to physically inspect the court. There is a long felt need in the art for an improved moisture control system that can measure the water flow rate through each zone, thus making the zone balancing process much quicker and easier for the user. There is a long felt need in the art for an improved moisture sensor that can be placed in a moist or wet environment without having to keep portions of the sensor from getting wet during use. Finally, there is a long felt need in the art for an improved display panel and attachment device that can be easily attached to an existing weather resistant box.

The present invention, in one exemplary embodiment, is an improved moisture control system that is designed to be installed as part of an irrigation system for a clay court the purpose of controlling the moisture level in each zone of the clay tennis court. The improved moisture control system includes one or more moisture sensors that are placed below the surface level of the clay court. In addition, the improved moisture control system includes a control unit that can read the moisture level at each moisture sensor and determine if the moisture level within the zone is between the user-specified lower and upper limits. Since the actual moisture levels are measured at each sensor, the improved moisture control system can adjust as needed regardless of the current weather conditions. The improved moisture control system replaces the manual shut-off valves for each zone with an electrically controlled valve. The improved moisture control system further includes a flow rate sensor that is placed in-line with each electrically controlled valve. Each zone includes an adjustable flow rate, which is preferably part of the electrically controlled valve. The improved moisture control system can be placed inside the existing valve box or located at another location specified by the user. Finally, the improved moisture control system can be controlled by the user at the control unit or remotely via a mobile device or computer using a novel software program that is installed on the control unit.

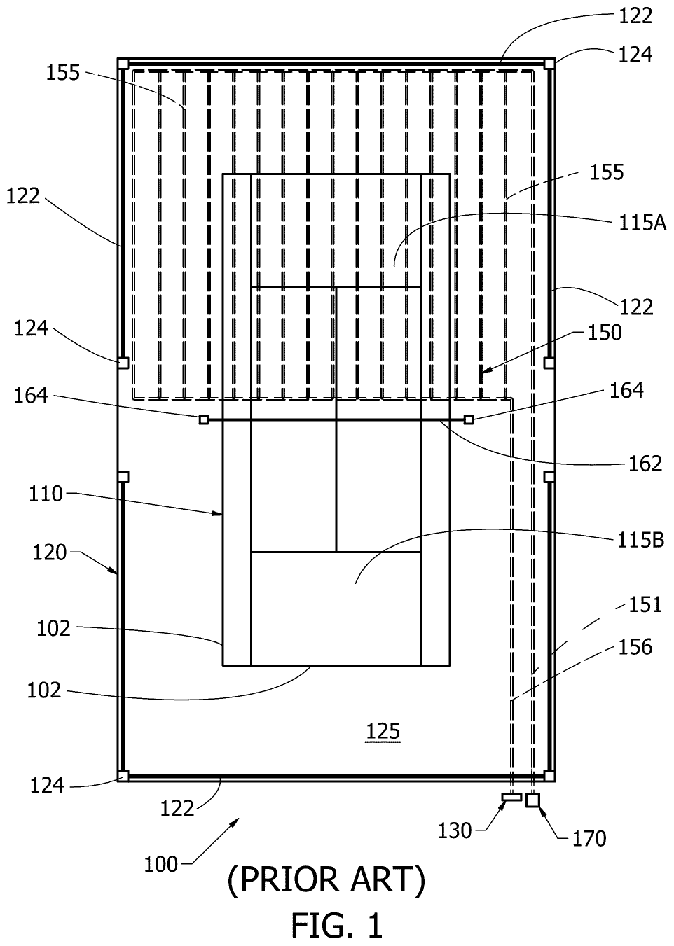

Referring initially to the drawings, FIG. 1 illustrates a layout view of a prior art clay tennis court having a below ground irrigation system 100. The improved moisture control system 10 is designed to be part of an irrigation system for a clay tennis court 100. FIG. 1 shows a typical clay tennis court 100 with a below-surface irrigation system 150 installed. It should be noted that this figure generally shows the layout and construction of a prior art below-surface irrigation system 150. The improved moisture control system 10 can be adapted to work with other irrigation layout designs and variations.

Tennis court 100 has a playing area 110 that is separated into smaller rectangular sections by court lines 102. Side one 115A and side two115B of tennis court 100 are further delineated by tennis net 162, which is held in a vertical position by net posts 164. Playing surface or clay court surface 125 typically spans across the entire playing area 110 to the fencing 122 and fence posts 124 creating the fenced-in area 120. Court lines 102 are held in place by nails placed through court lines 102 into the clay court surface 125.

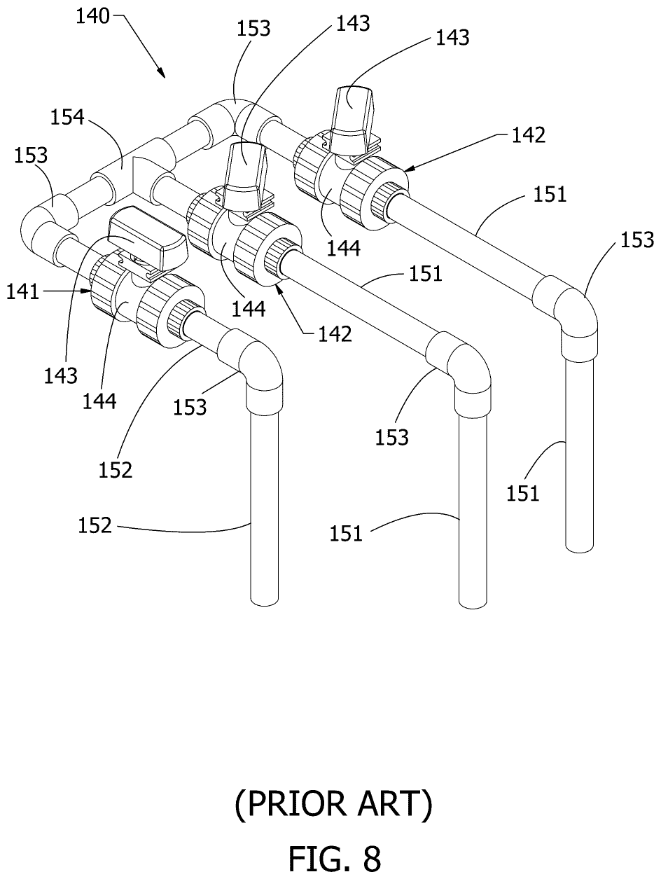

Water is supplied to the below-surface irrigation system 150 through a manual valve plumbing configuration 140 (also see FIG. 8), which is located inside valve box 170. Irrigation supply line 151 provides water to each separate zone on the tennis court. After the water reaches the individual irrigation pipe 151 that are positioned throughout the fenced-in area 120, holes within the irrigation pipes 151 allow water to flow out of the holes creating a water table below the surface of the court. Irrigation return pipe 156 will take any excess water that is not absorbed by the clay material or is used to fill the below surface water table back to drain 132, which exits the pipe into catch basin 132. FIG. 1 shows dashed lines to represent the system irrigation pipe 155 below the surface of the clay court surface 125. It should be noted that only side one 115A shows irrigation pipe 155. This is done for clarity purposes in the figure so that the playing area 110, including court line 102 will be clearly observed. Side two 115B also includes irrigation pipes 155 as well even though it is not shown on FIG. 1.

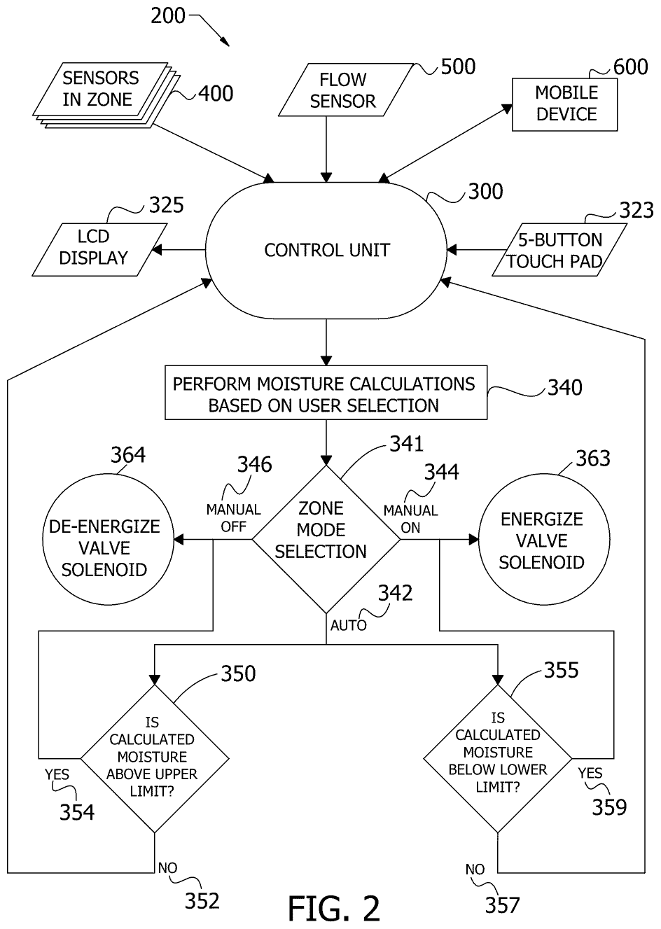

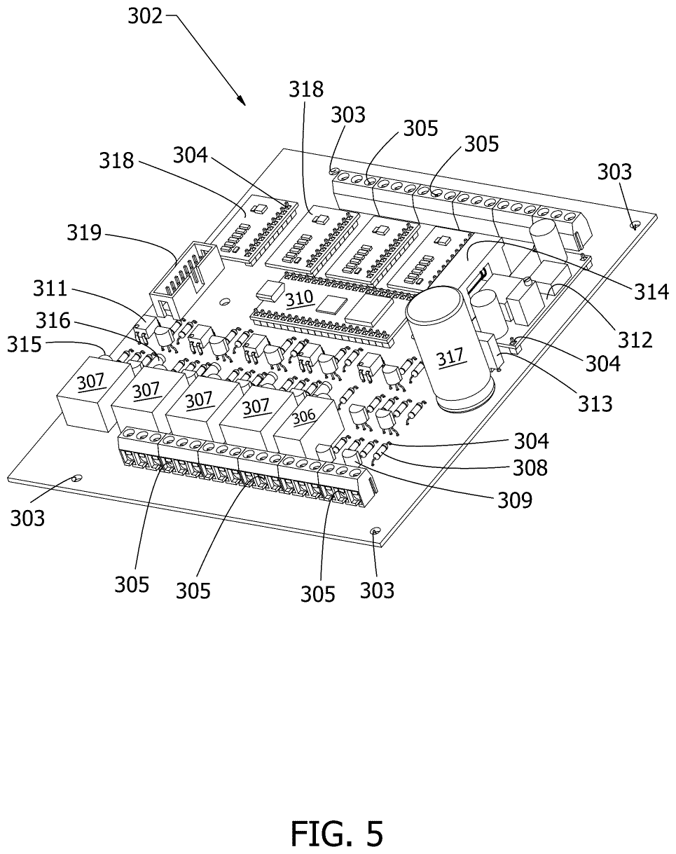

FIG. 2 illustrates a process flow diagram 200 for the present invention improved moisture control system 10 that can be incorporated into an irrigation system 100 as shown in FIG. 1. Control unit 300 includes a micro controller that will be discussed in more detail in FIG. 5. For now, it clearly is the “brain” of the improved moisture control system 10. Moisture sensors 400 that are buried throughout the fenced-in area 120 of the clay court surface 125 record a moisture reading that is sent back to the control unit 300.

Control unit 300 performs moisture calculations 340 on all of the individual moisture sensors 400. The moisture calculations 340 first separate each moisture reading into their assigned zones. Next, depending on the user's selection for each zone, the moisture readings in each zone are (i) averaged, (ii) maximum value determined, or (iii) minimum value determined. Whatever the selection criteria is selected by the user is then used to compare the calculated moisture value of the zone to the upper and lower control limits. If the calculated value is below the user selected lower limit, lower limit decision block 355 will determine that the condition has been met 359 causing the relay for the zone to turn-on and thereby energize valve solenoid 363. If the calculated value is above the user selected lower limit, lower limit decision block 355 will determine that the condition has not been met 357 and do nothing other than returning control to the control unit 300 to do other tasks. If the calculated value is above the user selected upper limit, upper limit decision block 350 will determine that the condition has been met 354 causing the relay for the zone to turn-off and thereby de-energize valve solenoid 364. If the calculated value is below the user selected upper limit, upper limit decision block 350 will determine that the condition has not been met 352 and do nothing other than returning control to the control unit 300 to do other tasks.

The algorithm for the control unit 300 also includes a manual override feature for each zone that the user may select. The user can make this selection via the 5-button touch pad 323 or by using the program or website via mobile device 600 using Wi-Fi or Bluetooth wireless communication. Every cycle through the program flow within the control unit 300, it goes through the Zone mode decision block 341 for each of the defined zones. The Zone mode decision block 341 has three options that can be selected by the user: (i) auto mode 342, (ii) manual on mode 344, and (iii) manual off mode 346. If the Zone mode decision block 341 is set to auto mode 342, the control unit 300 will let the moisture calculations 340 determine what to do with the relay controlling the valve solenoid. If the Zone mode decision block 341 is set to manual on mode 344, the control unit 300 will energize valve solenoid 363 and override the moisture calculations 340. If the Zone mode decision block 341 is set to manual off mode 346, the control unit 300 will de-energize valve solenoid 364 and override the moisture calculations 340.

A flow sensor 500 for each assigned zone is connected to control unit 300. As water flows through the hall-effect type flow sensor, it sends a signal back to control unit 300 that converts it into a flow rate reported in gallons per minute (gpm). Other units of measure could be re-programmed within control unit 300 as well. The flow rate of each zone, the moisture measurements for each sensor (reported in percent moisture), and other important data is displayed on the LCD display 325 that is located on the front of the display panel. In addition, this data can also be viewed by the user on their mobile device 600. Various configuration settings can be changed within control unit 300 using the 5-button touch pad 323 such as zone model selection, upper and lower control limits, moisture sensor calibration, Wi-Fi configuration, and much more.

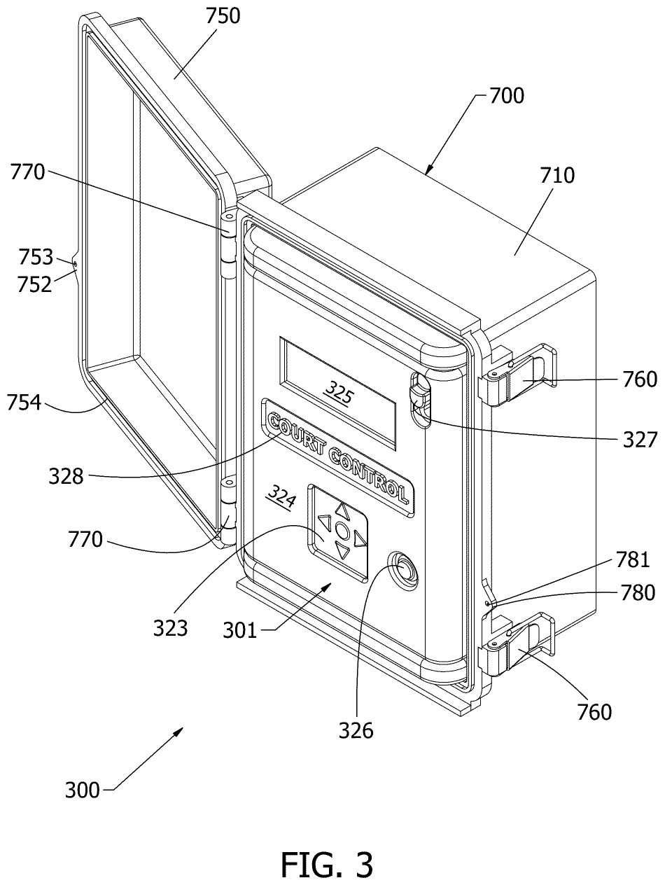

FIG. 3 illustrates a perspective view of the control unit 300 including the innovative mounting system of the display panel 301 within the waterproof plastic enclosure 700. Display panel 301 is protected by environmental conditions such as: rain, dirt, insects, and direct sunlight in addition to unauthorized users. Waterproof plastic enclosure 700 includes electrical box 710 for placing the printed circuit board 302, attaching wires from the moisture sensors 400, flow sensors 500, electric flow control valves 360, and 24-volt AC (alternating current) transformer 321. Waterproof plastic enclosure 700 further includes lid 750 that is pivotally supported to electrical box 710 by a pair of box hinges 770. Spring clip latch 760 engages with lid 750 to provide a tight fit. Lid 750 includes a water-tight seal 754 that is slightly compressed due to the clamping action of the spring clip latches 760. The combination of the two make a virtually water-tight seal between electrical box 710 and lid 750. The electrical box may include anti-tamper tab 780 and hole 781. Likewise, lid 750 may include anti-tamper tab 752 and hole 753. If the anti-tamper tabs are present on waterproof plastic enclosure 700, a separate lock or nylon electrical tie strap could be inserted through the two holes to prevent unauthorized access to the inside components. The waterproof plastic enclosure 700 is preferably made from plastic material and can be purchased from a variety of sources on the Internet and is typically referred to as junction box approximately 8.6 inches by 6.7 inches by 4.3 inches. The present invention can easily adapt to other sizes and configurations as well.

With lid 750 in the open position as shown in the figure, the user has access to display panel 301. The display panel front may include power switch 326, LCD display 325, and 5-button touch pad 323 that will provide the user with most of the normal operation functions. Pressing power switch 326 will either energize or de-energize control unit 300. LCD display 325 will provide the user with output data from the moisture sensors 400 and flow sensors 500, as well as various setup settings for the control unit 300. LCD display 325 is preferably a four-line 20-character serial bus-controlled module powered by 5 volts DC, which can be purchased from variety of sources on the Internet. The 5-button touch pad 323 is connected to control unit 300 and allows user input to any one of the five button switches. The 5-button touch pad 323 includes four buttons shaped as arrows with labels of “Before”, “Next”, “Inc”, and “Dec” that represent left, right, up, and down respectively. The middle button is labeled “Sel” that represents selected or okay. The 5-button touch pad 323 can be purchased from a variety of sources on the Internet and comes in various sizes and configurations.

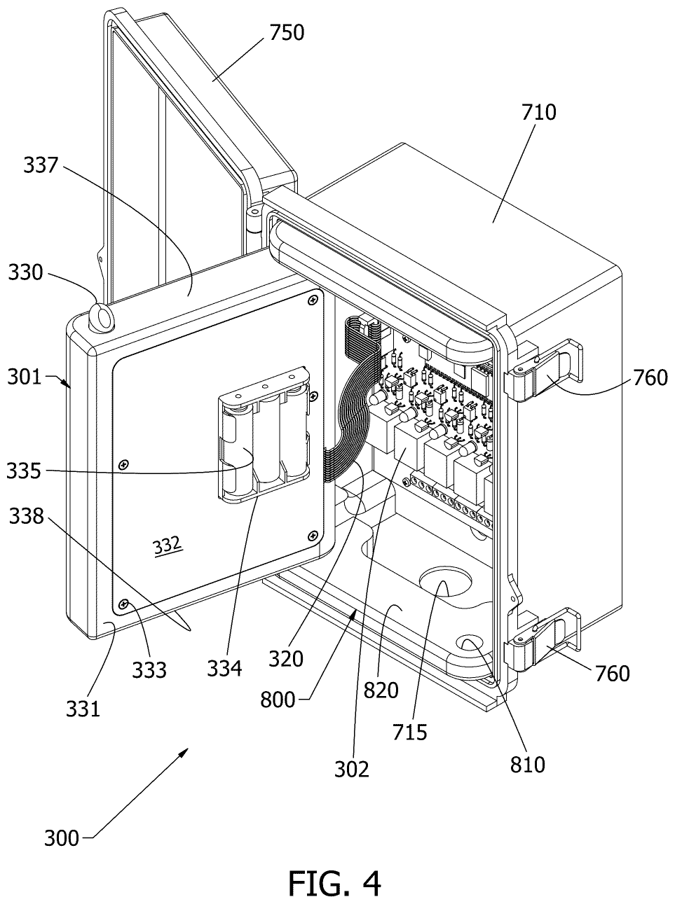

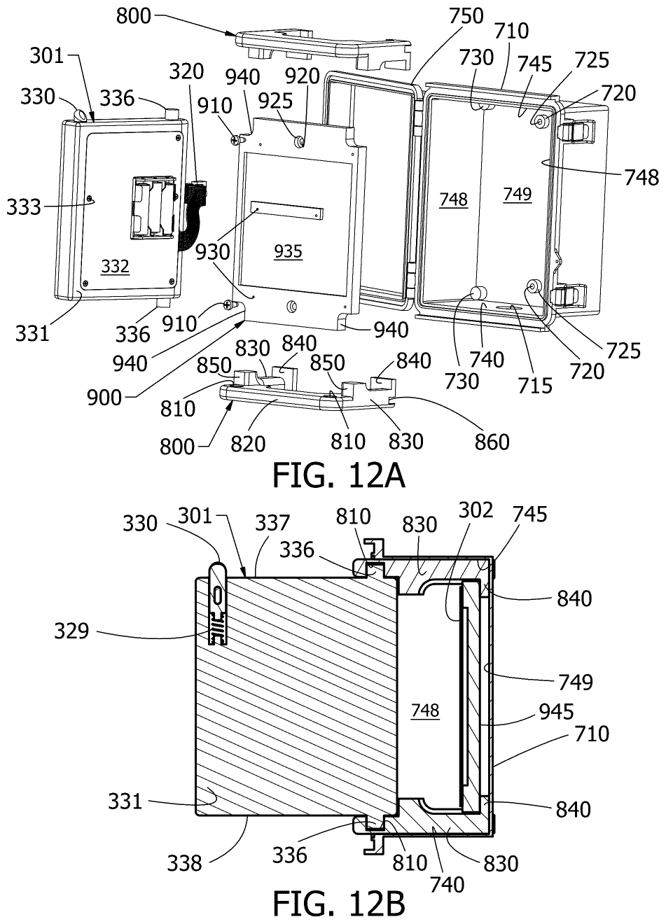

Display panel 301 includes a few additional features not directly related to normal user operations including product logo or name 328 and spring-loaded slide button 327. Since display panel 301 is preferably made from plastic, product logo or name 328 can be embossed into the display panel front 324. Low volume quantities of display panel 301 cand be 3-D printed from ABS or similar types of plastic. In higher volume quantities, display panel 301 could be made by injection molding process. Spring-loaded slide button 327 keeps the display panel 301 secured to electrical box 710 for normal operations of the control unit 300. If access is needed to the inside of the electrical box 710, the user simply pushes in a downward motion (i.e., towards power button 326) on spring-loaded slide button 327 causing the slide button to move downward in its track. When this occurs, the spring-loaded stop 330 is retracted from recess 810 (see FIG. 4) thus allowing display panel 301 to pivot open about display pivot post 336 (see FIG. 12).

FIG. 4 illustrates a perspective view of the control unit 300 in FIG. 3 with the display panel 301 in an open position to provide access to the printed circuit board 302 of the present invention. As previously described in FIG. 3 description, display panel 301 can be pivotally opened by sliding spring-loaded slide button 327 downward thereby retracting spring-loaded stop 330. Upon releasing spring-loaded slide button 327, spring-loaded stop 330 will return to its extended position as shown in FIG. 4. Display panel 301 is sized so that display panel top end 337 and display panel bottom end 338 will fit with a slight clearance between bridge portion 820 of saddle members 800. Spring-loaded stop 330 is sized so that it will fit into recess 810 formed in each of the saddle members. Further, display panel pivot post 336 (see FIGS. 12A and 12B) formed in display panel top end 337 and display panel bottom end 338 are also sized to fit into the same recess 810. Electrical box 710 includes a wire harness connector hole 715 formed in the box bottom surface 740. The actual size and placement can vary slightly depending on the installation of the waterproof plastic enclosure 700 as long as the hole and connector (not shown) do not interfere with wither the bridge portion 820 or printed circuit board 302. The display panel back 331 includes back cover 332, which is held in place by screws 333. Inside the display panel 301 ribbon cable 320 connects wires to LCD display 325, power switch 326, and 5-button touch pad 323.

Additionally, a particular embodiment of the present invention may include an internal battery power source for use in the event of a power outage. This embodiment includes battery holder 334, which is attached to the display panel 301 by one or two screws (not shown). Batteries 335 are then inserted into battery holder 334. In the embodiment of the present invention shown in FIG. 4, the batteries 335 are a standard AA, 1.5-volt battery. Other battery types, sizes, and voltages may also be used including rechargeable lithium batteries. It should be noted that not all embodiments of the present invention include an internal battery source.

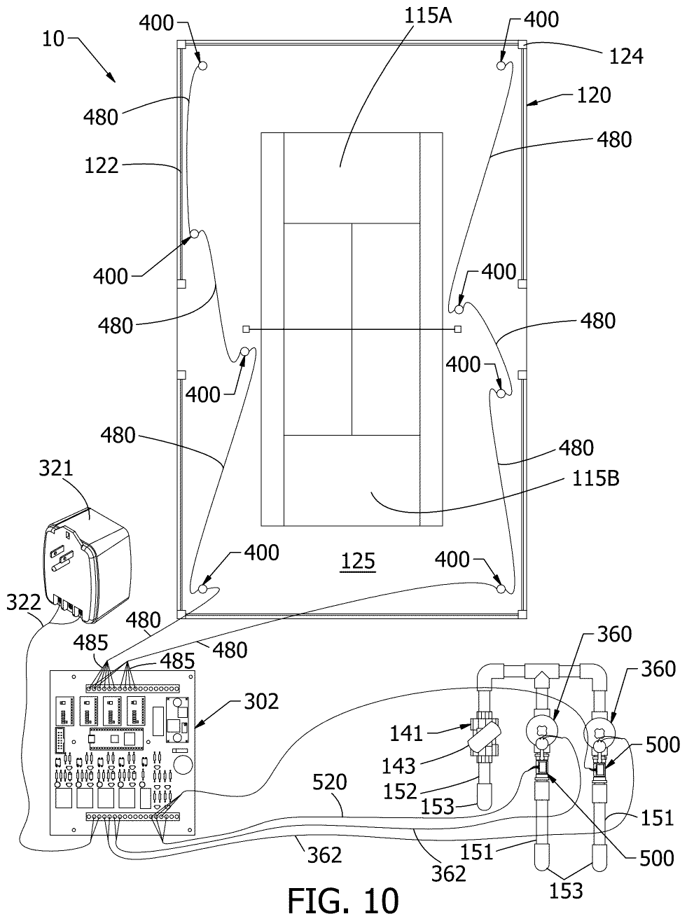

FIG. 5 illustrates a perspective view of the printed circuit board 302 shown in FIG. 4 of the present invention. Ribbon cable connector 319 attaches to ribbon cable 320 (see FIG. 3). Cable connecting wires 485 that are connected to moisture sensors 400 preferably attach to wire terminal attachment screws 305 along the upper portion of the board 302. The 24-volt AC transformer wires 322, flow sensors wires 520, and solenoid wires 362 (see FIG. 10) preferably attach to wire terminal attachment screws 305 along the bottom portion of the board 302. Board 302 is attached to support member 900 using screws 910 (see FIG. 12A) at mounting holes 303.

The printed circuit board 302 as depicted in FIG. 5 can control up to four zones and sixteen moisture sensors 400. For this reason, many of the components shown on board 302 may be reduced to provide fewer zones and fewer moisture sensors. However, additional zones and support for additional moisture sensors cannot be easily achieved currently due to limitations of the micro controller 310 used in the preferred embodiment. Other micro controllers may become available in the future that would allow the expansion of the number of moisture sensors 400. Four moisture sensors 400 are connected to one 4-channel analog-to-digital converter 318. The 4-channel analog-to-digital converter 318 used in the preferred embodiment is commonly available and ordered by its part number ADS1115. Each ADS1115 has its own printed circuit board and is mounted to the present invention printed circuit board 302 by ten solder attachment 304 locations as shown.

Micro controller 310 is preferably a Raspberry Pi Pico W, which is a single-board micro controller that was originally developed by the Raspberry Pi Foundation in the United Kingdom in association with Broadcom Inc. Recently this venture has become a public company, now known as Raspberry Pi Ltd., and is on the London Stock Exchange, and can easily be purchased from the Internet. Micro controller 310 includes 40-pins that can be configured as either inputs or outputs. Some of the pins can also be configured as a serial bus for other devices such as LCD display 325 and 4-channel analog-to-digital converter 318. Micro controller 310 further includes Wi-Fi connectivity using the 2.4 GHz 801.11n wireless LAN standard. This allows micro controller 310 to communicate with mobile device 600. Micro controller 310 can be programmed using either MicroPython or C/C++.

In addition to micro controller 310, printed circuit board 302 also includes a number of other electric components joined together will create the power source including power regulator 312, rectifier 313, capacity 317, and fuse holder 314. Rectifier 313 converts the incoming power supplied by 24-volt AC transformer 321 into DC. Further, power regulator 312 reduces the 24-volt DC down to a stable 5-volt DC source for most of the components on printed circuit board 302. Capacitor 317, preferably a 10,000-microfarad capacitor, provides a temporary source of power to board 302 in the event of a momentary power outage. Fuse holder 314 includes a low amperage fuse, preferably 3 amp, to protect the board circuitry in the event of a short circuit. The 24-volt relay 306 is energized when there is power coming from 24-volt AC transformer 321 and switches the power source to the optional internal 4.5-volt battery source, if battery holder 334 is present for the given embodiment of the present invention.

Most of the remaining components on board 302 form a branch circuit that is controlled by micro controller 310. There are up to four branch circuits, one for each zone. The branch circuit is commonly used with micro controllers and is well-known in the art. Specifically, the micro controller 310 decides when to energize or de-energize a particular zone. Since it uses a digital signal, various resistors 308, transistors 309, diode 316, and optocoupler 311 are joined together to energize or de-energize 5-volt relay 307 and LED 315, which in turn energizes or de-energizes electric flow control valve 360 for each zone. Finally, the flow sensors 500 require a pair of transistors 309 and resistors 308 to convert the incoming signal voltage from the flow sensor to 3-volts DC for micro controller 310. Each of the components are electrically connected to board 302 by solder attachments 304. Board 302 is known as a printed circuit board since it has multiple electrical connections “printed” on both sides of the board that properly connect each of the components based on the given wiring diagram schematic.

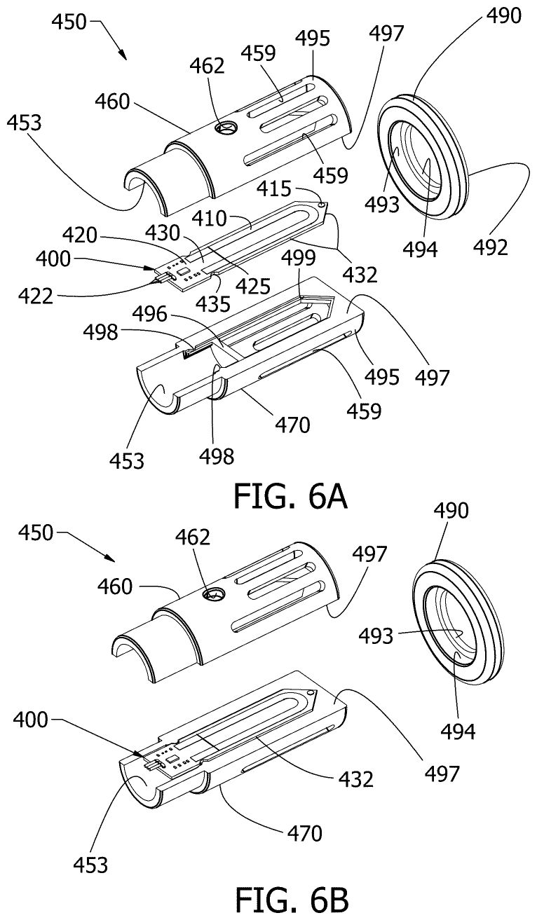

FIG. 6A illustrates an exploded perspective view of the innovative enclosure 450 for moisture sensor 400 of the embodiment of the present invention. Moisture sensor 400 is designed to be placed into the ground for the purpose of estimating the moisture in the soil. There are two main types of moisture sensors that are easily available on the Internet today. They operate on two slightly different electrical principles: (i) resistive and (ii) capacitive. The first type, resistive, measures the resistance of the surrounding soil. This type of sensor has been found to be less reliable than the capacitive type over long periods of time since the sensor electrodes tend to form oxides, thus leading to varying resistance.

Capacitive moisture sensors are more stable, but also have limitations. First, even though this sensor is designed to measure moisture within soil or clay, as is the case of the present invention, the sensor electronic portion 420 of moisture sensor 400 must remain dry to prevent sensor failure. Moisture sensor 400 includes a wet-dry separation line 425 on its printed circuit board 430. It separates the sensor electronic portion 420 from the sensor capacitive portion 410. Sensor capacitive portion 410, including sensor moisture contact 415, are placed into the soil or clay up to wet-dry separation line 425. Sensor 400 is attached to a 5-volt DC power supply and measures the capacitance within the soil or clay that is packed around moisture sensor 400. The analog signal is returned to 4-channel analog-to-digital converter 318 as a variable voltage ranging between 0 to 5 volts. The 4-channel analog-to-digital converter 318 converts the analog voltage into a digital signal and sends it to microcontroller 310.

Traditional applications using moisture sensor 400 have limitations due to the wet environment that the sensor must operate in. The innovative moisture sensor enclosure 450 of the present invention overcomes these limitations. FIG. 6A illustrates an exploded perspective view showing moisture sensor 400 prior to being placed between sensor clamshells 460 and 470. Two variations of moisture sensor enclosure 450 are included within the drawings and specification. In some cases, as in the first moisture sensor attached to moisture sensor cable 480 (see FIG. 10), only one cable access opening 462 is needed. In this case, moisture sensor enclosure 450 will include one sensor clamshell with cable access hole 460 and one sensor clamshell without cable access hole 470. Most of the time, the sensor 400 will be attached to an incoming moisture sensor cable 480 and an outgoing moisture sensor cable 480. In this situation, two cable access opening 462 are needed. In this case, moisture sensor enclosure 450 will include two sensor clamshell with cable access hole 460. Both clamshells 460 and 470 are identical except for the cable access hole 462 detail.

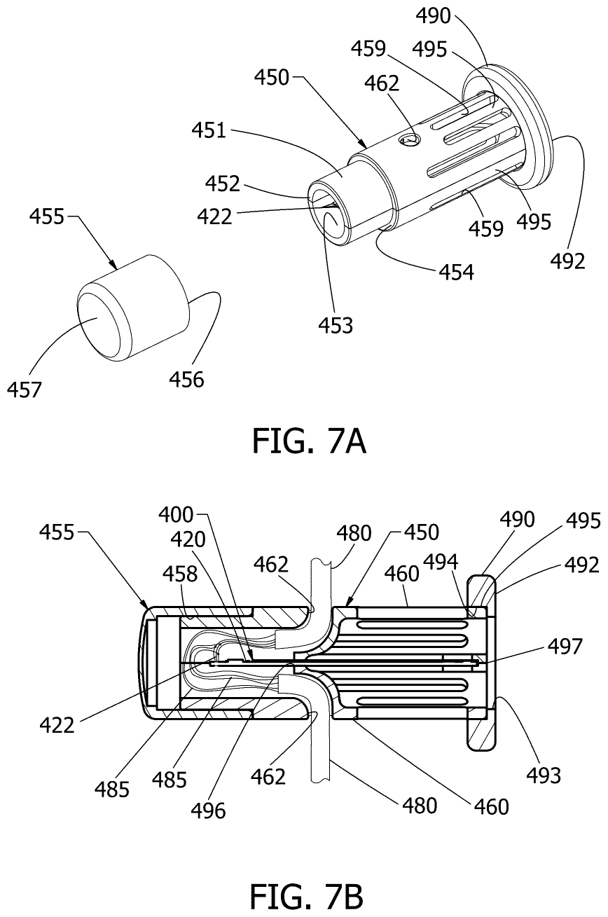

Clamshells 460 and 470 are designed specifically for moisture sensor 400 from ABS plastic but can be modified to use other types of plastic and other geometries based on the moisture sensor 400 size and shape. Clamshells 460 and 470 include multiple opening 459 throughout the lower portion of the moisture sensor enclosure 450. Openings 459 are required for clay to be packed around the sensor capacitive portion 420. Sensor 400, however, is protected along its board edges 432 once the two halves are assembled together. Clamshells 460 and 470 include recess 499, which is complimentarily shaped to fit moisture sensor 400. Flat surfaces on each clamshell 460 and 470 form a perimeter moisture barrier 497 after bonding the two halves together with a commonly used adhesive for plastic materials such as “super glue” or the like. Interior moisture barrier 496 formed in each clamshell 460 and 470 prevent moisture from entering into the sensor electronic portion 420, and is placed slightly below the wet-dry separation line 425. Alignment notch 498 formed in each clamshell 460 and 470 are used to align the sensor's alignment notch 435. Hollow portion 453 in each clamshell 460 and 470 provide adequate space to connect sensor signal wires 422 to the incoming and outgoing cable connecting wires 485 (see FIG. 7B).

Enclosure base 490 is sized to fit over clamshells 460 and 470 once the two halves are glued together with moisture sensor 400 secured between the two halves. Opening 493 is sized to fit tightly over, and glued to, the exterior surface 495 of each clamshell 460 and 470 (see FIG. 7B). Enclosure support surface 494 provides a stopping location for the now assembled clamshells 460 and 470 onto enclosure base 490. Enclosure support surface 494 includes an opening through to its bottom surface 492 to allow clay to enter the sensor capacitive portion 410. Enclosure base 490 is made from ABS plastic as well. Bottom surface 492 is sized to be slightly larger than the assembled clamshells 460 and 470 to help keep sensor 400 in an upright position when placing it into the hole formed in the clay, soil, or sand material.

FIG. 6B illustrates an exploded perspective view of the innovative enclosure 450 for the moisture sensor 400 of the embodiment of the present invention shown in FIG. 6A with moisture sensor 400 now placed within the lower clamshell 470 of the enclosure 450. As described in FIG. 6A, moisture sensor 400 is held in place by recess 499 and alignment notch 498. Adhesive or glue is applied around the board edges 432, the interior moisture barrier 496, and perimeter moisture barrier 497 prior to joining clamshell 460 and 470 sections together.

FIG. 7A illustrates an exploded perspective view of the innovative enclosure 450 for the moisture sensor 400 of the embodiment of the present invention shown in FIGS. 6A and 6B with moisture sensor 400 now installed within the enclosure 450 and ready for electrical connection. Once the adhesive is cured on moisture sensor enclosure 450, it is now ready to insert moisture sensor cable 480 into cable opening 462. The innovative design of enclosure 450 provides for a passageway of the sensor cable 480 into the hollow portion 453. Sensor signal wires 422 are then connected to cable connecting wires 485 as best shown in FIG. 7B. After all electrical connections are made within the moisture sensor enclosure 450, adhesive, silicone, or polyurethane is used to completely fill hollow portion 453 and any the space between moisture sensor cable 480 and opening 462. This is done to prevent moisture from entering this location once it is placed into service. Enclosure cap 455 having an open end 456 and closed end 457 is then placed over open end 452 and glued to exterior surface 451 of moisture sensor enclosure 450. Enclosure cap 455 is sized to fit tightly over exterior surface 451 and meet up with cap stop location 454.

FIG. 7B illustrates a sectional view of the innovative enclosure 450 for the moisture sensor 400 of the embodiment of the present invention shown in FIGS. 6A, 6B, and 7A with moisture sensor 400 now completely encased by the enclosure 450 and enclosure cap 455, and electrically connected to moisture sensor cable(s) 480. The sectional view show interior moisture barrier 496 and perimeter barrier 497 blocking moisture from reaching sensor electronic portion 420. It also shows the tight fit-up between interior surface 458 of enclosure cap 455 and exterior surface 451 of moisture sensor enclosure 450. It also shows the tight fit-up between opening 493 on enclosure base 490 and exterior surface 495 on clamshells 460. This particular configuration shown in FIG. 7B uses two sensor clamshell with cable access hole 460 members.

FIG. 8 illustrates a perspective view of a prior art manual valve plumbing configuration 140 for two manually operated zone valves 142 attached to one manually operated supply line valve 141. A below-surface irrigation system 150 (see FIG. 1) includes valve box 170, which is positioned in near proximity to the fenced-in area 120 of the clay tennis court. Valve box 170 is above ground and usually includes a removable lid for providing access to manual main water shut-off valve 141 and manual water zone shut-off valves 142. Water main supply 152 enters valve box 170 typically from below the ground surface. Typical main supply 152 is delivered to the valve box 170 by ¾ or 1 inch pipe at standard commercial water pressure and flow rates ranging from 50-90 psi and 20-50 gpm, respectively. The water main supply is then separated into the individual zones through a combination pipe, elbows 153, and T-joints 154.

Manual main water shut-off valve 141 is shown in the fully open position in FIG. 8 having shut-off valve handle 143 in line with valve body 144. Manual water zone shut-off valves 142 are shown in a partially open position, thereby reducing the flow rate to each zone through irrigation pipe 151. The summation of the water flow rates of each zone exiting irrigation pipes 151 is approximately equal to the flow rate leaving manual main water shut-off valve 141. So, flow rate to each zone 151 can be varied by changing the handle positions of either the manual main water shut-off valve 141 or the specific manual water zone shut-off valves 142. This is part of the trial-and-error described previously herein when balancing the traditional manual valve plumbing configuration 140.

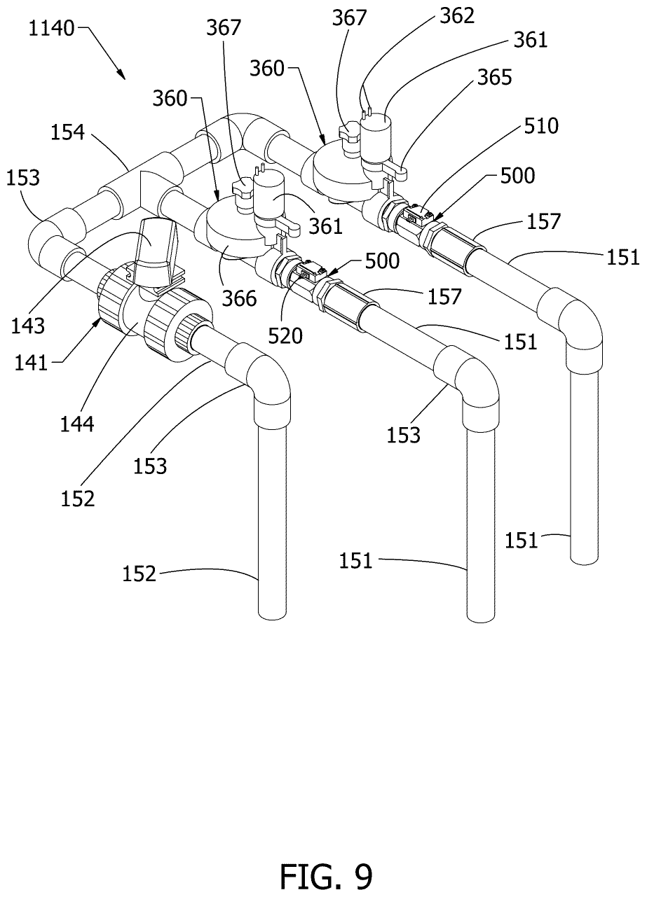

FIG. 9 illustrates a perspective view of a plumbing configuration 1140 for two electrically controlled zone valves 360 attached to one manually operated supply line valve 141 of the present invention described in FIG. 2. As shown in FIG. 8, water main supply 152 enters valve box 170 typically from below the ground surface. Typical main supply 152 is delivered to the valve box 170 by ¾ or 1 inch pipe at standard commercial water pressure and flow rates ranging from 50-90 psi and 20-50 gpm, respectively. The water main supply is then separated into the individual zones through a combination pipe, elbows 153, and T-joints 154. Manual main water shut-off valve 141 is shown in a partially open position in FIG. 9.

Manual water zone shut-off valve 142 has now been replaced with electric flow control valve 360 for each zone. Electric flow control valve 360 includes valve body 366 that further includes electric solenoid 361 and flow control know 367. When 24-volt AC power is supplied to solenoid wires 362, solenoid 361 will actuate an internal portion of the valve, thereby opening the valve and allowing water to flow through the valve body 367. Flow rate can be adjusted by turning flow control knob 367 in one direction to increase the flow and turning the knob 367 in the other direction to decrease the flow. The particular model of electric flow control valve 360 shown in the figure includes a valve manual override 365, which can be used to manually turn-on the valve or turn-off the valve. This is sometime helpful during initial system setup and maintenance. The preferable electric flow control valve 360 can be purchased on the Internet from companies such as Galcon. Other types of electronically controlled valves could be used in the present invention as well, including valves that have a separate flow control device for each zone.

In addition to replacing manual water zone shut-off valve 142 with electric flow control valve 360, flow sensor 500 has also been added to each irrigation supply line 151, preferably placed directly after valve 360. Flow sensor 500 includes a hall-effect sensor 510. As water passes through the sensor, the flow causes a small internal impellor to rotate. As the flow rate increases, the speed of the impellor increases as well. As the impellor rotates, it creates an electrical pulse signal to be sent back to the micro controller 310 through flow sensor wires 520. This is then converted into a gallons per minute measurement. The technology associated with hall-effect sensors is well-known in the art. The particular application in the present invention provides essential feedback to the user, thereby reducing the trial-and-error commonly needed to balance the flow rates through each irrigation supply pipe 151. The Flow sensor can be purchased on the Internet from various companies including Digiten. Depending on the plumbing configuration, various elbows 153, T-joints 154, and threaded pipe couplings 157 may be needed to complete the plumbing portion of the improved moisture control system 10 of the present invention.

FIG. 10 illustrates a layout view of a clay tennis court having a below ground irrigation system 100 with the improved moisture control system 10 of the present invention now installed. Moisture sensors 400 are preferably connected together by moisture sensor cable 480 as shown. Ideally, four moisture sensors 400 are connected together such that cable connecting wires 485 will provide connection to the printed circuit board through a single cable 480 as opposed to running separate cables 480 to each sensor 400. Using the preferrable method as shown for connecting sensors 400 to cable 480, can reduce the amount of wire needed. Cable 480 is commonly used in irrigation systems today and comes in various number of wires within the cable. Common sizes include 18/4, 18/5, and 18/7, which means 18-gauge copper wire with either 4, 5, or 7 wires within the cable. Based on this information, cable 480 between the first two sensors 400 shown on side one 115A could use 18/4 since three wires are needed for the first sensor 400 and four wires are needed for the second and first sensors 400 combined. Next, 18/5 cable 480 could be used between the second sensor 400 and third sensor 400 since five wires will now be needed (two for power to the sensors, one for each sensor signal wire). Finally, 18/7 cable 480 could be used between the last sensor 400 and the connection to the printed circuit board 302 since six cable connecting wires 485 are needed. This process can be repeated for the cable 480 connecting the other four sensors 400 together as well.

Printed circuit board 302 is shown in the figure without the other components of control unit 300 for simplification purposed in this figure. Clearly, printed circuit board 302 depends on the other components of control unit 300 as fully described in the other figures herein including FIG. 3. With that understanding, cable connecting wires 485 for moisture sensors 400 preferably attach to the upper wire terminal attachment screws 305 of printed circuit board 302 as shown. The 24-volt AC transformer 321 is powered by standard AC power and is connected to transformer wires 322 that lead back to the lower wire terminal attachment screws 305 on printed circuit board 302. Electric flow control valve 360 is connected to printed circuit board 302 by solenoid wires 362 as shown. Flow sensor 500 is connected to printed circuit board 302 by flow sensor wires 520 as shown.

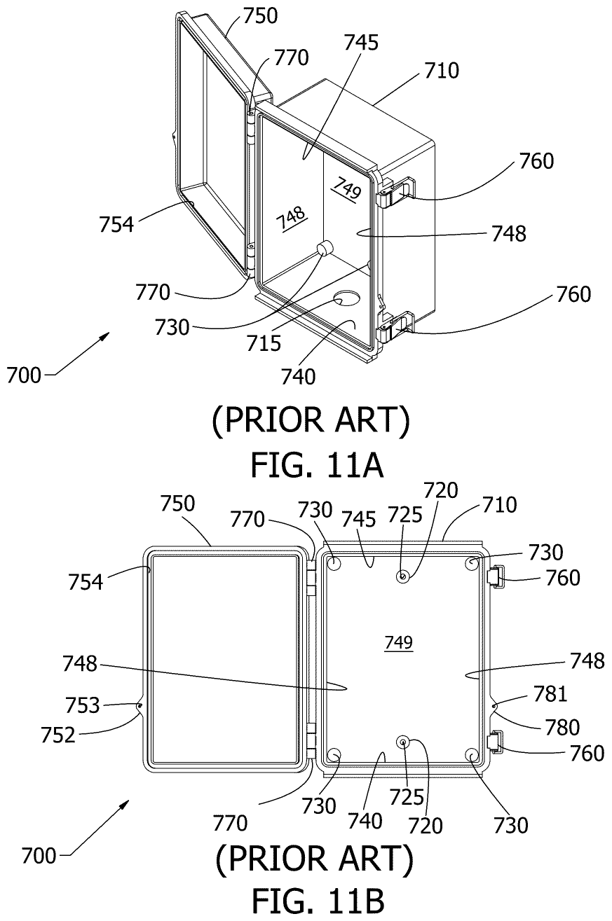

FIG. 11A illustrates a perspective view of the prior art waterproof plastic enclosure 700 of the present invention 10 shown in FIG. 3. The prior art waterproof plastic enclosure 700 can now be further described without the presence of control unit 300. Electrical box 710 has internal box side surfaces 748, box top surface 745, and box bottom surface 740. Lid 750 is shown in an open position. Support post 730 are formed on the box back surface 749 as shown. The conventional function of post 730 is to provide a mounting support location for box 710 on the back side of the box (opposite side of box back surface 749 not shown). In the conventional, prior art application, support post 730 served no other function.

FIG. 11B illustrates a frontal view of the prior art waterproof plastic enclosure 700 shown in FIG. 11A showing the internal mounting locations on the back side 749 of box 710. This particular view of box 710 now shows threaded mounting post 720 and threaded hole 725. In the conventional, prior art application, threaded mounting post 720 and threaded hole 725 are used for supporting internal components including printed circuit boards. No other attachment locations are provided other than what is shown for internal components.

FIG. 12A illustrates an exploded perspective view of the innovative control unit 300 depicting the innovative mounting system for the display panel 301 and the waterproof plastic enclosure 700 of the embodiment of the present invention 10 shown in FIG. 3. The innovative mounting system only relies on support post 730, threaded mounting post 720, and the internal surfaces (740, 745, 748, and 749) of box 710 to secure display panel 301 and printed circuit board 302. The mounting system does not require any additional holes or openings made in waterproof plastic enclosure 700 for securing the internal control unit 300 components as described above. Wire harness connector hole 715 will be made waterproof using proper connectors, as needed.

Saddle member 800 includes bridge portion 820 and leg portion 830. Bridge portion 820 further includes recess 810 positioned near each box side surface 748 and performs two functions. Recesses 810 pivotally support display panel 301 via display panel pivot posts 336. Also, recess 810 aligns with spring-loaded stop 330 along display panel top end 337. When display panel 301 is in the closed position, ledge 850 contacts display panel back 331 thus providing necessary support for display panel 301. This support is needed when the user presses 5-button touch pad 323 that is located on the front side of display panel 301.

Leg portion 830 of saddle member 800 extends inward and contacts box back surface 749 when it is secured in place. Foot 840 provides additional contact and support for leg portion 830. Opening 860 in the bottom surface of foot 840 and leg portion 830 is sized to slide over support post 730.

Support member 900 includes recess 925 and recessed mounting hole 920 to receive screw 910 that is threaded into threaded hole 725 of box 710. Prior to securing support member 900 to box 710, saddle member is pivotally attached to display panel 301 at both the top and bottom locations, then leg 830 is slid down over support post 730. Rounded corner 940 is sized and shaped to slide over leg 830. This creates an interlocking support between display panel 301, saddle member 800, and support member 900 once screw 910 in threaded into threaded mounting hole 715. PC board mounting hole 930 is proved for attaching printed circuit board 302 or any other component or board. Recessed surface 935 is positioned and sized so that solder attachments 304 of the back side of printed circuit board 302 do not interfere with the attachment of the board 302 to support member 900.

FIG. 12B illustrates a partial sectional view of the innovative control unit 300 depicting the innovative mounting system for the display panel 301 and the waterproof plastic enclosure 700 shown in FIG. 12A. This figure now shows the pivotal connection of display panel 302 that is created between display panel pivot posts 336 and recesses 810 in saddle member 800. Further, this figure also shows the interlocking of saddle member 800 (specifically saddle leg 830, foot 840), support member 900 (specifically support member back surface 945 and rounded corner 940), and electrical box 710 (specifically support post 730, box side top surface 745, box side surfaces 748, box bottom surface 740, and box back surface 749). Compression spring 329 for controlling the motion of spring-loaded slide button 327 and spring-loaded stop 330 on display panel 301 can also be seen in this sectional view as well.

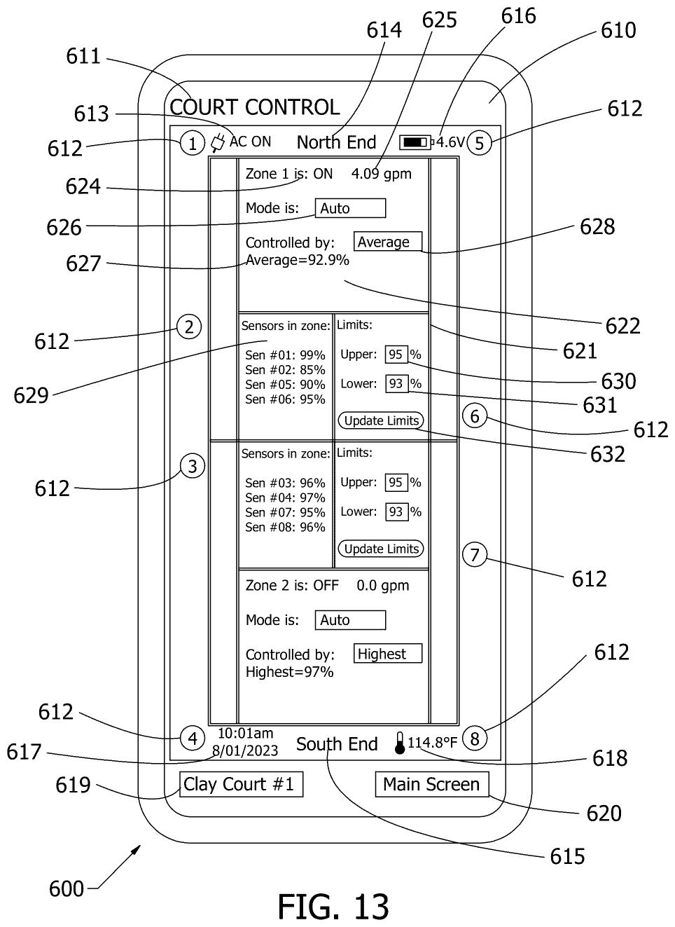

FIG. 13 illustrates a frontal view of a mobile device 600 with the innovative software program or webpage 610 displayed for the present invention 10. Mobile device 600 is a cellular phone as depicted in the figure. However, the software program can also run on other devices such as computers or tablets. The preferred software used in the control unit 300 is a combination of MicroPython, Java Script, HTML (i.e., Hypertext Markup Language), and CSS (i.e., Cascading Style Sheets) programming. Other programming languages, such as C/C++ are viable as well. Various features of the user interface are shown in the figure. While this is the preferred embodiment, other user interface configurations are possible. This is by example only.

The user interface includes the program title 611, which currently is “Court Control.” Moisture sensor locations 612 are displayed at the approximate location of the moisture sensors 400. The user interface includes tennis court layout 621 and labels for court end name 614 and 615 as configured by the user in the setup configuration. Court selection dropdown menu 619 allows the user to select a different court in the case of one control unit 300 controlling two courts. Program screen or page selection dropdown menu 620 allows the user to go into setup configuration and calibration of the moisture sensors 400.

For embodiments of the present invention 10 that include an internal backup battery, control unit external power indicator 613 and control unit internal battery voltage indicator 616 can inform the user of problems with the external power and/or when the internal batteries 335 need to be replaced. Other system data can be displayed for the user as well. Screen refresh time and date 617 can let the user know when the micro controller 310 last sent out updated information for display on mobile device 600. Finally, control unit internal temperature indicator 618 can let the user know the temperature inside waterproof plastic enclosure 700.

Zone information 622 is displayed within tennis court layout 621 as shown in the figure. Preferably, one zone for each end of the court is displayed. However, the user interface for the present invention 10 can easily be modified to show additional zones if needed. For instance, court selection dropdown menu 619 could be replaced by a zone selection dropdown menu instead. Zone sensor data 629 displays the moisture sensor number, which corresponds to moisture sensor location 612, and current moisture percentage for each moisture sensor 400 in the particular zone. When sensor calibration is performed, a completely water saturated moisture sensor 400 will be set to one hundred percent, and a dry sensor moisture sensor 400 will be set to zero percent.

Zone status 624 will be displayed for the displayed zone, including its assigned zone number, which could be a value between one and four. Included in zone status 624 will be either “ON” or “OFF” depending on its current condition. This will let the user know if the electric control valve 360 is currently energized 363 or de-energized 364. Zone flowrate 625 reported in gallons per minute (gpm) will also be displayed. Other flow rate units can be selected as well. Zone mode dropdown menu 626 gives the user the option to select “Auto”, “Manual On”, or “Manual Off” as previously described herein. Zone calculation dropdown menu 628 gives the user the option to select “Average”, “Highest”, or “Lowest” as previously described herein. Based on the user selection for the Zone calculation dropdown menu 628, the zone moisture sensor calculation 627 is displayed as well. Notice that Zone 1 displayed in FIG. 13 is controlled by the average value of the four moisture sensors 400 in the zone, while Zone 2 is controlled by the highest value of the four sensors 400 in the zone. This is shown as an example only. Zone upper limit selection 630 and zone lower limit selection 631 are updated by the user by first changing the value in either or both limits 630 and 631, then pressing the Zone update limits button 632.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “improved moisture control system”, “improved moisture control device”, “novel device”, and “innovative design” are interchangeable and refer to the improved moisture control system 10 and the improved moisture control system flowchart 200 of the present invention.

Notwithstanding the forgoing, the improved moisture control system 10 of the present invention can be of any suitable size and configuration as is known in the art without affecting the overall concept of the invention, provided that it accomplishes the above stated objectives. One of ordinary skill in the art will appreciate that the size, configuration and material of each of the improved moisture control system 10 as shown in the FIGS. are for illustrative purposes only, and that many other sizes and designs of the improved moisture control system 10 are well within the scope of the present disclosure. Further, as stated herein, the improved moisture control system has been shown throughout the FIGS. incorporated into a below ground irrigation system for clay tennis courts but could be adapted to above ground irrigation systems and other types of playing surfaces other than clay tennis courts that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A moisture control irrigation system comprising:
a housing;
a control unit; and
a moisture sensing component in electrical communication with the control unit, wherein the moisture control system is configured to optimize an irrigation system.

2. The moisture control irrigation system of claim 1, wherein the housing comprises an electrical box, a lid, an anti-tamper element and a water-tight seal, and further wherein the control unit is retained within the housing.

3. The moisture control irrigation system of claim 1, wherein the control unit component comprises a display and a micro controller.

4. The moisture control irrigation system of claim 1, wherein the control unit component comprises a printed circuit board comprising a plurality of branch circuits configured to control at least two zones of the irrigation system.

5. The moisture control irrigation system of claim 1, wherein the control unit component comprises a moisture calculation module.

6. The moisture control irrigation system of claim 1, wherein the control unit component comprises a zone mode decision block.

7. The moisture control irrigation system of claim 1, wherein the moisture sensing component comprises a plurality of moisture sensors.

8. The moisture control irrigation system of claim 7, wherein each of the plurality of moisture sensors comprises an electronic portion, a moisture content portion, and a wet-dry separation line.

9. The moisture control irrigation system of claim 7, wherein each of the plurality of moisture sensors comprises a clam shell enclosure body with a moisture barrier.

10. The moisture control irrigation system of claim 1, wherein said control unit further includes a flow sensor for measuring water flow rate through each zone.

11. The moisture control irrigation system of claim 10, wherein the flow sensor is a hall effect sensor.

12. A moisture control irrigation system comprising:
a water-tight housing;
a control unit component comprising a moisture calculation module and a zone mode decision block retained within the water-tight housing; and
a moisture sensing component comprising a plurality of moisture sensors in electrical communication with the control unit, wherein the moisture control system is configured to optimize a multi-zone irrigation system.

13. The moisture control irrigation system of claim 12, wherein the moisture calculation module is configured to perform a moisture calculation for a plurality of data received from each moisture sensor.

14. The moisture control irrigation system of claim 13, wherein each moisture calculation is configured to set a threshold based on an average of the plurality of data received from each moisture sensor.

15. The moisture control irrigation system of claim 13, wherein each moisture calculation is configured to set a threshold based on a maximum value reading from the plurality of data received from each moisture sensor.

16. The moisture control irrigation system of claim 13, wherein each moisture calculation is configured to set a threshold based on a minimum value reading from the plurality of data received from each moisture sensor.

17. The moisture control irrigation system of claim 12, wherein the zone mode decision block comprises an automatic mode, a manual on mode, and a manual off mode.

18. The moisture control irrigation system of claim 12, wherein the control unit component further comprises a manual override.

19. A moisture control irrigation system comprising:
an irrigation component for a clay tennis court;
a housing;
a control unit component comprising a moisture calculation module and a zone mode decision block retained within the housing;
a moisture sensing component comprising a plurality of moisture sensors in electrical communication with the control unit, wherein the moisture control irrigation system is configured to optimize a multi-zone irrigation for the clay tennis court; and
a flow sensor for measuring a water flow rate through each of the multi-zone irrigation.

20. The moisture control irrigation system of claim 19, wherein the irrigation component comprises a water supply and a piping structure in fluid communication with the water supply and is configured to supply at least two different zones of the multi-zone irrigation for the clay tennis court.
